(19) United States
(12) Patent Application Publication
(10) Pub. No.: US 2002/0099956 A1
(43) Pub. Date: Jul. 25, 2002

(54) Information processing apparatus and storage medium

(75) Inventor: Tomoyuki Suzuki, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/101,057

(22) Filed: Mar. 20, 2002

Related U.S. Application Data
(63) Continuation of application No. PCT/JP99/06518, filed on Nov. 22, 1999.

(51) Int. Cl. H04L 9/00

(52) U.S. Cl. 713/200

(57) ABSTRACT

An information processing apparatus is constructed to include an input section which inputs information and instruction, a comparing section which compares an input operation pattern from the input section with one or a plurality of registered operation patterns which are registered in advance depending on the operation mode, and a control section which controls the operation mode to a state where the operation from the input section is impossible based on a comparison result of the comparing section.

### TECHNICAL FIELD

The present invention generally relates to information processing apparatuses and storage media, and more particularly to an information processing apparatus which has a security function and a computer-readable storage medium which stores a program for causing a computer to have a security function.

### BACKGROUND ART

Recently, with the spread and the improvement in performance of personal computers, strengthened security for preventing an unauthorized user other than an authorized user of the personal computer from using the personal computer illegally, and rewriting, deleting and copying data has become of a greater demand.

As a first example of a conventional security method, a method is proposed in which a desktop personal computer is equipped with a lock, for example. In this case, it is impossible to turn ON the personal computer unless an authorized user opens the lock.

Also, as a second example of the conventional security method, a method is proposed in which the starting of the BIOS or OS or, resuming from the screensaver is prohibited unless a password is input from a keyboard of the personal computer. In this case, it is impossible to use the personal computer without inputting of correct password.

However, in the first example, there was a problem in that even an authorized user could not use the personal computer when the user forgets to bring or loses the key. In addition, there was also a problem in that it becomes possible for an unauthorized user to use the personal computer when the key is stolen or duplicated.

On the other hand, in the second example, it is possible to use the personal computer as long as the authorized user does not forget the password. However, there was a problem in that password is likely to be set to a number that is easy to remember, such as the birth date of the authorized user and the like, so as not to forget the password. Thus, there was a danger in that the password may be presumed relatively easily by an unauthorized user. For this reason, there was a problem in that it becomes possible for the unauthorized user to use the personal computer when the unauthorized user correctly presumes the password.

Further, in the first and second examples, there was a problem in that, after the personal computer once becomes usable by use of the key or the input of the password, it is possible for any person to use the personal computer while the authorized user is not at his seat.

In addition, it is conceivable to use a plurality of locks, a long password or a plurality of passwords, or further, a combination of the lock and the password. However, in each of these conceivable cases, since the operation required by the user becomes complex, the operability of the personal computer deteriorates and at the same time, the load on the user becomes large.

### DISCLOSURE OF THE INVENTION

Hence, it is a general object of the present invention to provide a novel and useful information processing apparatus and storage medium, in which the above-described problems are solved.

A more specific object of the present invention is to provide an information processing apparatus having a security function which can relatively easily and positively prevent an unauthorized user from using the information processing apparatus illegally, and to provide a computer-readable storage medium which stores a program for causing a computer to have such a security function.

Another object of the present invention is to provide the information processing apparatus which includes an input section which inputs information and instruction, a comparing section which compares an input operation pattern from said input section with one or a plurality of registered operation patterns which are registered in advance depending on the operation mode, and a control section which controls the operation mode to a state where an operation from said input section is impossible based on a comparison result of said comparison section. According to the information processing apparatus of the present invention, it is possible to relatively easily and positively prevent an unauthorized user from using the information processing apparatus illegally.

Another object of the present invention is to provide a computer-readable storage medium which stores a program for causing a computer to have a security function, and causes the computer to carry out a comparing procedure which compares an input operation pattern with one or a plurality of registered operation patterns depending on an operation mode of the computer, and a control procedure which controls the operation mode to a state where the input operation is impossible based on a comparison result of said comparing procedure. According to the storage medium of the present invention, it is possible to relatively easily and positively prevent an unauthorized user from using the computer illegally.

Other objects and further features of the present invention will be apparent from the following detailed description when read in conjunction with the accompanying drawings.

### BRIEF DESCRIPTION OF THE DRAWINGS

FIG. 1 is a perspective view showing an embodiment of an information processing apparatus according to the present invention;

FIG. 2 is a block diagram showing the structure of an important part of a main body shown in FIG. 1;

FIG. 3 is a flow chart for explaining the operation of a CPU;

FIG. 4 is a block diagram showing a power circuit section;

FIG. 5 is a flow chart for explaining an input operation pattern registration process of the CPU;

FIG. 6 is a diagram showing an input operation pattern register/delete screen;

FIG. 7 is a diagram showing a registration select screen which is displayed when a register button is selected;

FIG. 8 is a diagram showing a registration screen which is displayed when a security selecting button for selecting security during the power-ON state is selected;

FIG. 9 is a diagram showing an input operation pattern which is registered after the registration is stated;

FIG. 10 is a diagram showing a screen for setting the time when the power can be turned ON, which is displayed when a setting button for setting the time when the power can be turned ON is selected;

FIG. 11 is a diagram showing a condition setting screen which is displayed when a condition setting button in a registration screen is selected; and

FIG. 12 is a diagram showing an input operation pattern which is registered after the registration is started.

### BEST MODE OF CARRYING OUT THE INVENTION

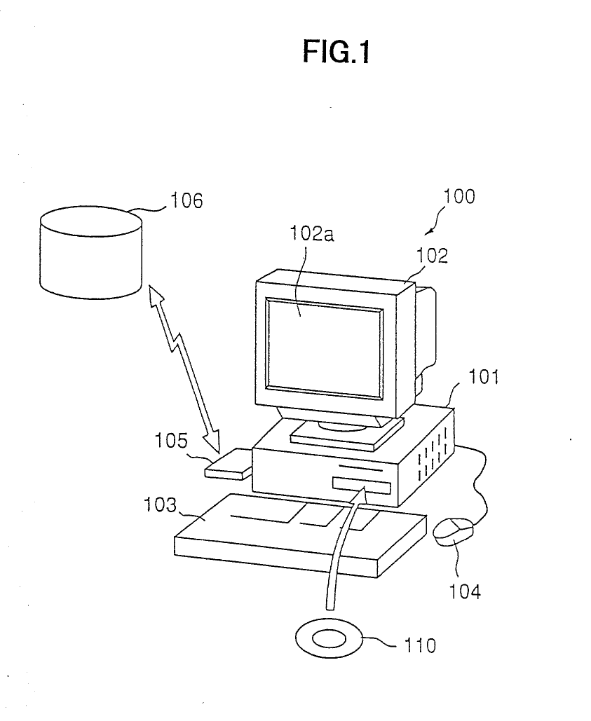

FIG. 1 is a perspective view showing an embodiment of an information processing apparatus according to the present invention. In this embodiment, the present invention is applied to a desktop computer system. However, the present invention may also be similarly applied to a portable computer system and the like.

A computer system 100 shown in FIG. 1 is generally provided with a main body 101 which includes a CPU, a disk drive and the like, a display 102 which includes a display screen 102a for displaying an image in response to an instruction from the main body 101, a keyboard 103 which is used to input various information to the computer system 100, a mouse 104 which is used to specify an arbitrary position on the display screen 102a of the display 102, and a modem 105 which is used to access an external database or the like and to download programs or the like stored in another computer system.

A program (security software) which causes the computer system 100 to have a security function and is stored in a portable storage medium such as a disk 110 or, is downloaded from a storage medium 106 of another computer system using a communication unit such as the modem 105, is input to the computer system 100 and compiled. A computer-readable storage medium according to the present invention is formed by a recording medium, such as the disk 110, which stores the program. The recording medium forming the storage medium according to the present invention is not limited to portable recording media such as the disk 110, IC card memory, floppy disk, magneto-optical disk and CD-ROM, but also includes various kinds of recording media which are accessible by a computer system which is coupled via the communication unit or communication means such as the modem 105 and LAN.

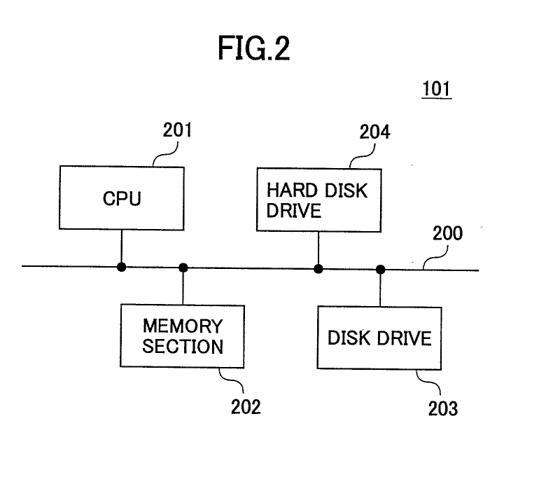

FIG. 2 is a block diagram for explaining the structure of an important part within the main body 101 of the computer system 100. In FIG. 2, the main body 101 generally includes a CPU 201, a memory section 202 made of RAM, ROM or the like, a disk drive 203 for the disk 110, and a hard disk drive 204 which are connected via a bus 200. In addition, the display 102, the keyboard 103, the mouse 104 and the like may be connected to the CPU 201 via the bus 200 or, connected directly to the CPU 201, although the illustration thereof will be omitted.

Of course, the structure of the computer system 100 is not limited to that shown in FIGS. 1 and 2, and various other known structures may be used instead.

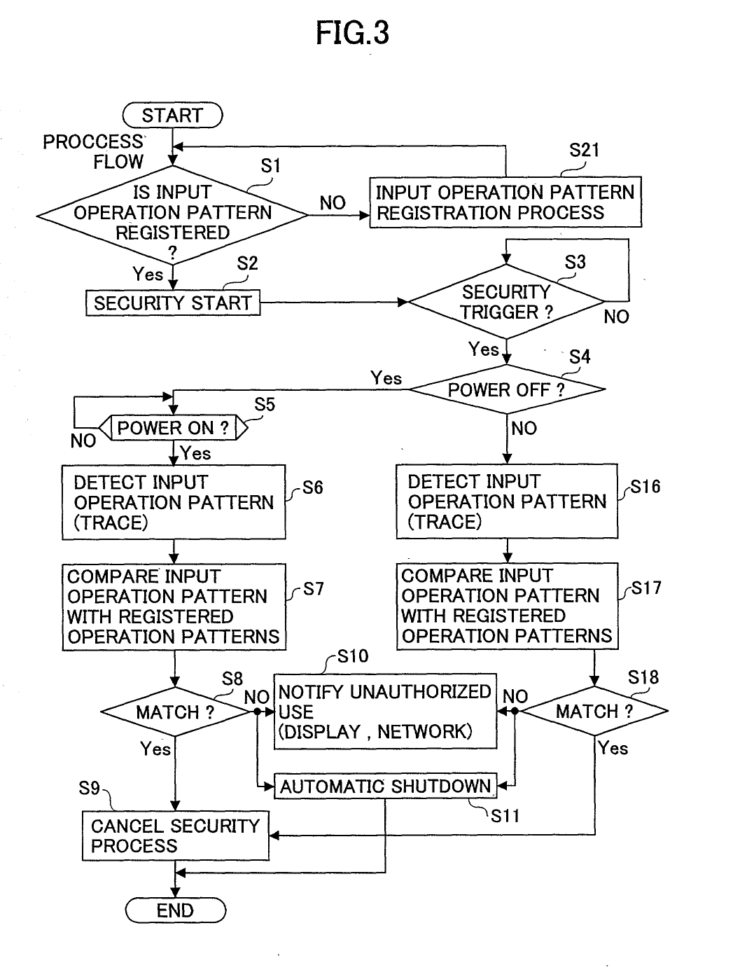

FIG. 3 is a flow chart for explaining the operation of CPU 201 of this embodiment. In FIG. 3, a step S1 decides whether or not an input operation pattern is registered. If the decision result in the step S1 is NO, the process advances to a step S21 which is described later. It will be assumed for the sake of convenience that the input operation pattern is registered, and the process from and after the step S1 will be described.

If the decision result in the step S1 is YES, a step S2 starts a security process and a step S3 decides whether or not a security trigger exists. The security is triggered when the power is turned ON and the computer system 100 is started, when an operation mode is switched from a suspend mode to a resume mode, when there is no input from the keyboard 103, the mouse 104 and the modem 105 for a predetermined time in a specific operation mode or, when a camera, an infrared sensor or the like detects that a user is not in an operating position of the computer system 100, or the like, for example. If the decision result in the step S3 is YES, a step S4 decides whether or not the power of the computer system 100 is OFF.

If the decision result in the step S4 is YES, a step S5 decides whether or not the power is turned ON. If the decision result in the step S5 is YES, a step S6 detects the input operation pattern. The input operation pattern refers to a pattern of a plurality of operations carried out with respect to the computer system 100 by making inputs from at least one of the keyboard 103, the mouse 104 and the modem 105. The input operation pattern may be such that an order of the operations is completely fixed or, an order includes at least a part of random order where the order of the operations may be changed. For example, the input operation pattern starts a second application after a first application is started and thereafter starts a third application.

A step S7 compares the input operation pattern with the input operation patterns immediately after the power is turned ON which are registered in the memory section 202 or the like in advance, that is, compares the input operation pattern with the registered operation patterns with respect to the operation mode immediately after the power is turned ON. One or more operation patterns may be registered. In a case where a plurality of registered operation patterns are registered, the input operation pattern is compared with all of the registered operation patterns to search for a matching registered operation pattern. A step S8 decides whether or not the input operation pattern and the compared registered operation pattern match. If the decision result in the step S8 is YES, a step S9 cancels the security process and the process ends.

On the other hand, if the decision result in the step S8 is NO, steps S10 and S11 are carried out simultaneously. A step S10 notifies the computer system 100 of unauthorized use. The unauthorized use is notified by displaying a message on the display 102, transmitting a message to another computer system via the modem 105, or outputting a buzzer sound or a voice message in the main body 101. In addition, a step S11 automatically shuts down the computer system 100 and the process ends.

In this embodiment, the power of the computer system 100 is automatically turned OFF by the shutdown. However, instead of performing the shutdown automatically, it is possible to employ a method such as locking the keyboard 103, for example so that the computer system 100 is controlled to a state where the input operation is impossible. The point is, if the unauthorized use is detected, to control the computer system 100 to a state where the input operation is impossible by locking the keyboard 103, turning the power OFF or the like, and the computer system 100 may further be prohibited from being restarted. In addition, in a case where the restart of the computer system 100 is prohibited, the step S10 may inform the state where the input operation is impossible and/or the prohibition of restart.

On the other hand, if the decision result in the step S4 is NO, a step S16 detects the input operation pattern. A step S17 compares the input operation pattern with the input operation patterns in the power-ON state which are registered in the memory section 202 or the like in advance, that is, the registered operation patterns for the operation mode after a predetermined time elapses from the power-ON state. The operation mode after the predetermined time elapses from the power-ON state refers to a state where one or more applications are started, a state where a screen saver is in operation, a state where no input operation is performed for a predetermined time since the last input operation, or the like. Also in this case, one or more registered operation patterns may be registered. In addition, in a case where a plurality of registered operation patterns are registered, the input operation pattern is compared with all of the registered operation patterns to search for the matching registered operation pattern. Thus, one or more registered operation patterns are registered in advance for each operation mode. A step S18 decides whether or not the input operation pattern and the compared registered operation pattern match. If the decision result in the step S18 is YES, the step S9 cancels the security process and the process ends as described above. On the other hand, if the decision result in the step S18 is NO, the above-described steps S10 and S11 are carried out simultaneously.

The steps S8 and S11 compare the input operation pattern with the registered operation patterns and decide whether or not the patterns are the same. However, as a modification, the steps S8 and S11 may judge whether or not a difference between the input operation pattern and the registered operation pattern is within a tolerable range. For example, in a case where registered operation patterns A, B, C and D are registered, the difference may be judged as being within the tolerable range when the input operation pattern starts from A, B and C, when the input operation pattern starts from at least A and B and ends with D, or when the input operation pattern includes A, B, C and D regardless of the order.

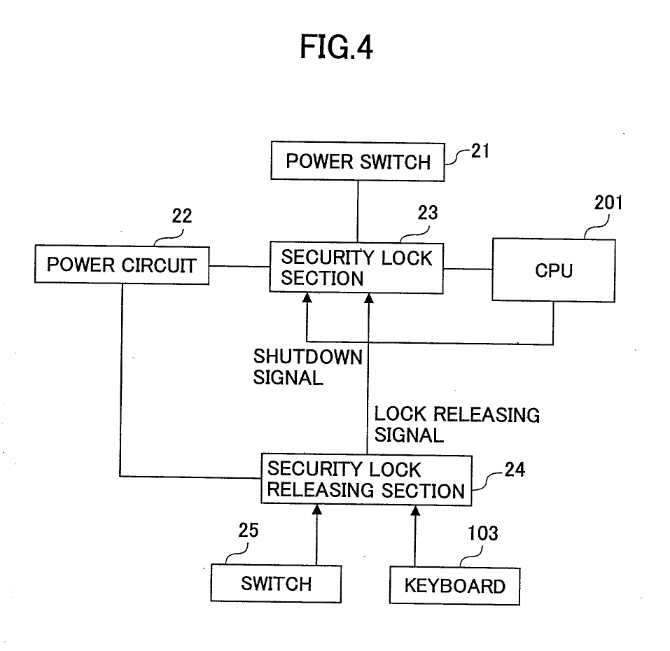

FIG. 4 is a block diagram showing a power circuit section in the main body 101 of the computer system 100. The power circuit section includes a power switch 21, a power circuit 22, a security lock section 23 and a security lock releasing section 24, and is connected to the CPU 201 as shown in the FIG. 4.

The power circuit 22 supplies a power source voltage to at least the security lock releasing section 24 irrespective of the operation mode. The security lock section 23 supplies the power source voltage from the power circuit 22 to the CPU 201 when the power switch 21 is turned ON in the state where the lock is released, and the computer system 100 assumes the power-ON state. On the other hand, if a shutdown signal for automatically making the shutdown is generated in the above-mentioned step S11, the security lock section 23 assumes the locked state in response to the shutdown signal. In this locked state, the security lock section 23 cuts off the supply of the power source voltage from the power circuit 22 to the CPU 201, even when the power switch 21 is turned ON.

The security lock releasing section 24 is provided so as to set the security lock section 23 in the locked state to the lock released state. Even if the computer system 100 is in the shutdown state, the security lock releasing section 24 generates a lock releasing signal in response to a reset signal which is generated by events such as when a reset switch 25 which is provided at a predetermined part of the computer system 100 is manipulated or, when a plurality of keys on the keyboard 103 are pressed in a predetermined sequence or pressed simultaneously. The security lock section 23 which is in the locked state is controlled to the lock released state in response to the lock releasing signal.

Next, a registration process of the input operation pattern will be described. In FIG. 3, if the decision result in the step S1 is NO, the step S21 carries out the registration process of the input operation pattern, and the process returns to the step S1. The registration of the input operation pattern may be carried out by a manual register operation or, may be carried out automatically by causing the CPU 201 to monitor the operation ordinarily made by the authorized user.

FIG. 5 is a flow chart for explaining the registration process of the input operation pattern of the CPU 201. In FIG. 5, a step S31 starts a pattern registration program to cause the CPU 201 to register the input operation pattern. The pattern registration program may be included in the program (security software) which causes the computer system 100 to have the security function or, may be a separate program. The computer-readable storage medium of the present invention may store this pattern registration program.

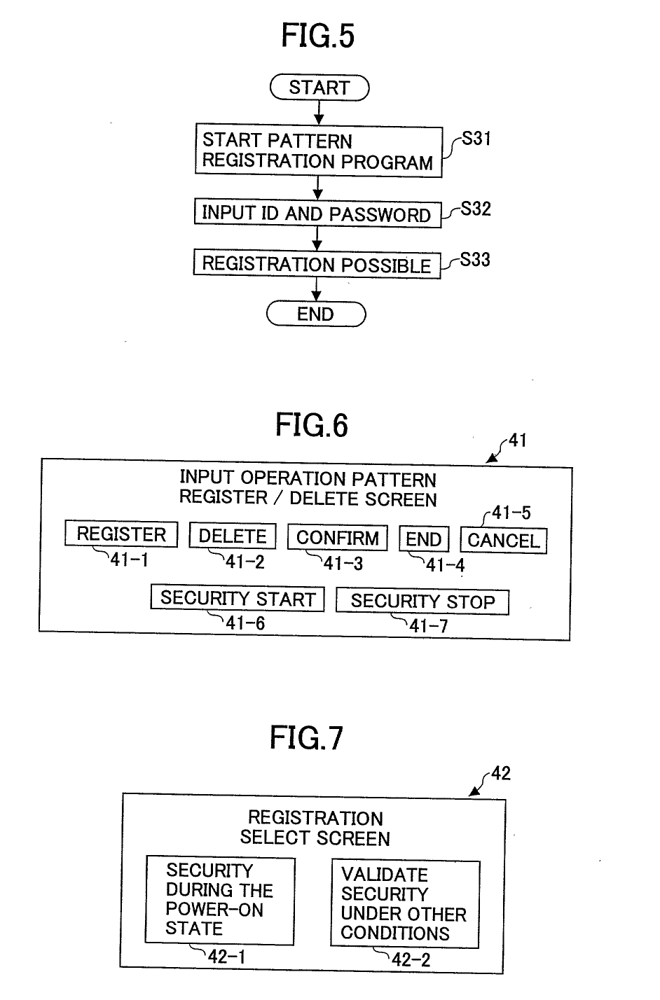

A step S32 displays a message on the display 102 which prompts input of the ID of the authorized user and the password, and inputs the ID and password input from the keyboard 103. A step S33 confirms whether or not the input ID and password match the registered ID and password by a known method, and if they match, displays a screen 41 such as that shown in FIG. 6 on the display 102 and enables the pattern registration. When the registration operation ends in this state, the process shown in FIG. 5 ends.

FIG. 6 is a diagram showing an input operation pattern register/delete screen 41. The pattern register/delete screen 41 displays a register button 41-1, a delete button 41-2, a confirm button 41-3, an end button 41-4, a cancel button 41-5, a security start button 41-6 and a security stop button 41-7, and a corresponding process starts when a button is clicked and selected by the mouse 104.

FIG. 7 is a diagram showing a registration select screen 42 which is displayed on the display 102 when the register button 41-1 is selected. The registration select screen 42 displays a selecting button 42-1 for selecting security during the power-ON state and a selecting button 42-2 for making the security valid in the suspend or other operation modes, that is, under other conditions.

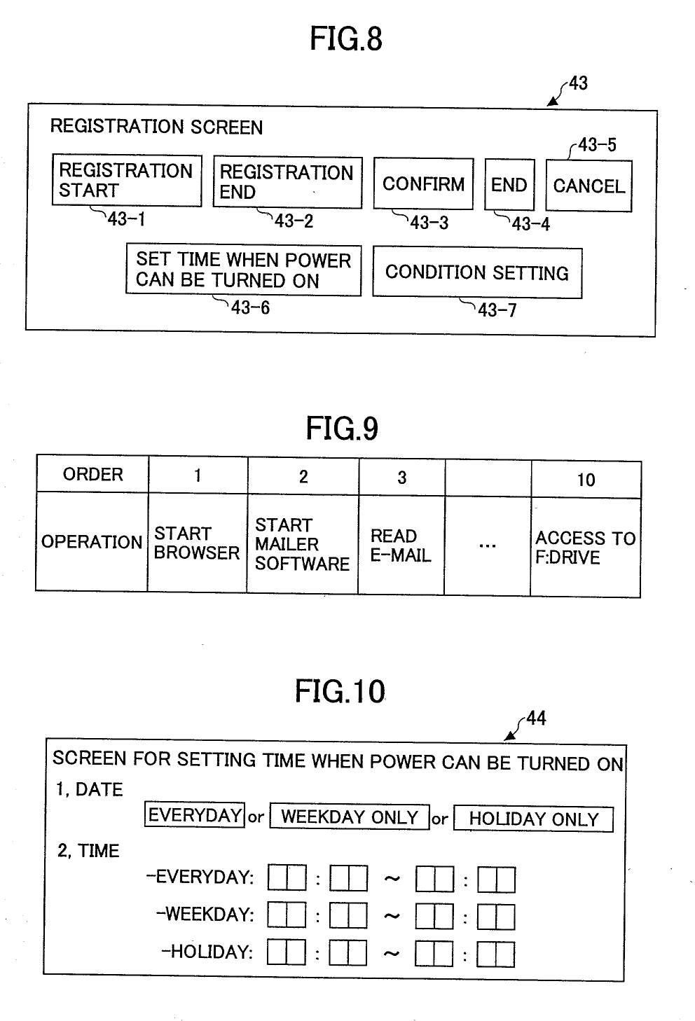

FIG. 8 is a diagram showing a registration screen 43 which is displayed on the display 102 when the selecting button 42-1 for selecting security during the power-ON state is selected. The registration screen 43 displays a registration start button 43-1, a registration end button 43-2, a confirm button 43-3, an end button 43-4, a cancel button 43-5, a setting button 43-6 for setting the time when the power can be turned ON, and a condition setting button 43-7.

In this embodiment, the input operation by the authorized user is monitored from the time when the registration start button 43-1 is selected to the time when the registration end button 43-2 is selected, and the input pattern such as that shown in FIG. 9 is registered, for example. FIG. 9 is a diagram showing the input pattern which is registered after the registration is stated, and shows a case where the input operation pattern includes ten input operations.

FIG. 10 is a diagram showing a screen 44 for setting the time when the power can be turned ON, which is displayed on the display 102 when the setting button 43-6 in the registration screen 43 is selected. The screen 44 displays the date, time and the like, and the authorized user sets the conditions which enable the power to be turned ON. Hence, the continuous operation of the computer system 100 becomes possible only during the time which is set and when the power can be turned ON or, when the difference between the input operation pattern and the registered operation pattern which is registered for the security during the power-ON state is within a tolerable range.

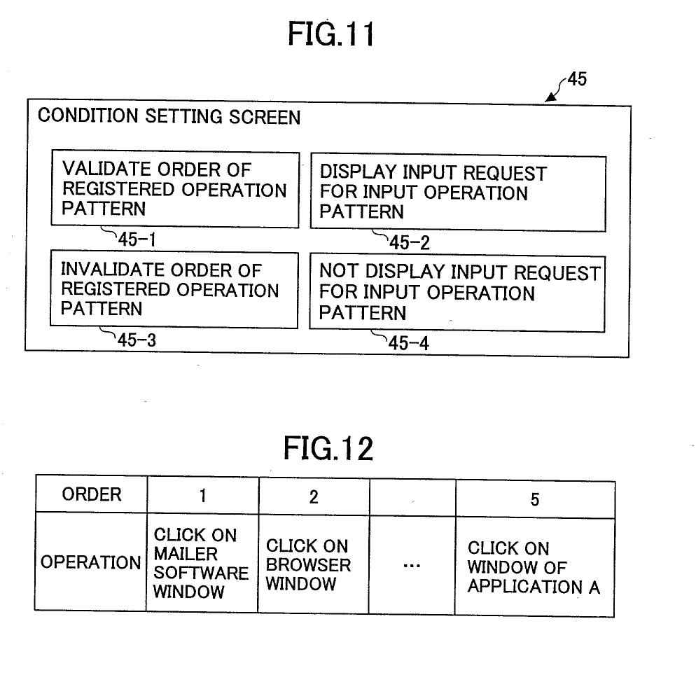

FIG. 11 is a diagram showing a condition setting screen 45 which is displayed on the display 102 when the condition setting button 43-7 in the registration screen 43 is selected. The condition setting screen 45 displays a button 45-1 for validating the order of the registered operation pattern, a button 45-2 for displaying an input request for the input operation pattern, a button 45-3 for invalidating the order of the registered operation pattern, and a button 45-4 for not displaying the input request for the input operation pattern.

If the button 45-1 for validating the order of the registered operation pattern is selected, the tolerable range of the difference between the input operation pattern and the registered operation pattern becomes narrower, and the computer system 100 is shut down unless these two operation patterns match. In addition, if the button 45-3 for invalidating the order of the registered operation pattern is selected, the tolerable range of the difference between the input operation pattern and the registered operation pattern becomes wider, and the continuous operation of the computer system 100 is possible as long as the same operations are performed in an arbitrary order even if these two patterns do not match completely.

On the other hand, if the button 45-2 is selected, it is possible to display the input request for the input operation pattern, and to prompt the user to operate with the input operation pattern. In addition, if the button 45-4 for not displaying the input request is selected, the unauthorized user can not recognize that the security is in operation.

In addition, in the registration select screen 42 shown in FIG. 7, if the selecting button 42-2 is selected, the security is validated in the suspend or other operation modes, that is, under other conditions. In this case, the input operation by the authorized user from the time when the registration start button 43-1 in the registration screen 43 shown in FIG. 8 is selected to the time when the registration complete button 43-2 is selected is monitored, and the input operation pattern such as that shown in FIG. 12 is registered. FIG. 12 is a diagram showing the input operation pattern which is registered after the registration is started, and shows a case where the input operation pattern including five input operations is registered.

As described above, according to this embodiment, the authorized user can register the input operation pattern in order to realize the security with very easy operation with hardly being conscious of the registration operation. In addition, the security is canceled automatically by merely performing the operations as usual without being conscious of the security cancel operation, and without the need for operations such as opening the key or inputting the password in order to cancel the security.

Further, the registered operation pattern may be updated regularly by providing a learning function in the information processing apparatus.

Further, the present invention is not limited to these embodiments, but various variations and modifications may be made without departing from the scope of the present invention.

1. An information processing apparatus comprising:
an input section which inputs information and instruction;
a comparing section which compares an input operation pattern from said input section with one or a plurality of registered operation patterns which are registered in advance, depending on the operation mode; and
a control section which controls the operation mode to a state where the operation from said input section is impossible based on a comparison result of said comparison section.

2. The information processing apparatus as claimed in claim 1, wherein said comparing section outputs a match signal if a difference between the input operation pattern from said input section and the one or plurality of registered operation patterns is within a tolerable range, and said control section controls the operation mode to the state where said operation is impossible in response to said match signal.

3. The information processing apparatus as claimed in claim 1 or 2, wherein said control section controls the operation mode to the state where said operation is impossible, and at the same time, prohibits a restart of the information processing apparatus.

4. The information processing apparatus as claimed in any of claims 1 to 3, which further comprises a notifying section which notifies the state where said operation is impossible and/or the prohibition of restart.

5. The information processing apparatus as claimed in any of claims 1 to 4, which further comprises a canceling section which cancels the state where said operation is impossible and/or the prohibition of restart.

6. The information processing apparatus as claimed in any of claims 1 to 5, which further comprises a registration part which stores the input operation pattern from said input section and automatically registers said one or plurality of registered operation patterns.

7. A computer-readable storage medium which stores a program for causing a computer to have a security function, said program causing the computer to carry out:
a comparing procedure which compares an input operation pattern with one or a plurality of registered operation patterns depending on an operation mode of the computer; and
a control procedure which controls the operation mode to a state where the input operation is impossible based on a comparison result of said comparing procedure.
